(19) United States
(12) Patent Application Publication
(10) Pub. No.: US 2022/0207484 A1
(43) Pub. Date: Jun. 30, 2022

(54) TRAINING DATA GENERATION TECHNIQUES TO CAPTURE ENTITY-TO-ENTITY AFFINITIES

(71) Applicant: Microsoft Technology Licensing, LLC, Redmond, WA (US)

(72) Inventors: Ankan SAHA, San Francisco, CA (US); Siyao SUN, Mountain View, CA (US); Zhanglong LIU, Fremont, CA (US); Aastha JAIN, Sunnyvale, CA (US)

(21) Appl. No.: 17/139,993

(22) Filed: Dec. 31, 2020

(51) Int. Cl. G06Q 10/10; G06N 20/00

(52) U.S. Cl. CPC G06Q 10/1053; G06N 20/00

(57) ABSTRACT

Techniques for generating training data to capture entity-to-entity affinities are provided. In one technique, first interaction data is stored that indicates interactions, that occurred during a first time period, between a first set of users and content items associated with a first set of entities. Also, second interaction data is stored that indicates interactions, that occurred during a second time period, between a second set of users and content items associated with a second set of entities. For each interaction in the first interaction data: (1) a training instance is generated; (2) it is determined whether the interaction matches one in the second interaction data; and (3) if the interaction does not match, then a negative label is generated for the training instance, else a positive label is generated for the training instance. Machine learning techniques are then used to train a machine-learned model based on the generating training instances.

### TECHNICAL FIELD

The present disclosure relates to machine learning and, more particularly, to techniques for generating training data for one or more machine-learned models in an efficient way.

### BACKGROUND

Some content platforms host millions of content items of various types, such as profile pages, feed items, articles, and opportunity listings. Determining what to present on a screen of a computing device that accesses a content platform is challenging due, in part, to the large number of content items to display. Even when the computing device is not interacting with the content platform, the content platform may determine to generate notifications for certain content items and send those notifications to the computing device.

Content platforms have implemented sophisticated techniques to know what to select and present. One type of technique is machine learning to train a model that scores content items for relevance. Higher scored content items may be selected over lower score content items. However, training a machine-learned model may take a significant amount of time due to the amount of data available.

For example, some online connection networks include tens of millions of users, many of which interact with many content items. In order to train an accurate model, the training data should include a training instance for each possible node-content item pair. However, a significant number of training instances would have negative labels, since no user has interacted with even a relatively small percentage of all available content items on the content platform. Thus, the time and computing resources required to generate the training data and train a model using machine learning techniques would be substantial. Therefore, techniques are required to reduce the time and computing resources necessary to generate training data sufficient to train an accurate model.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for training a machine-learned model, in an embodiment;

FIG. 2A is a block diagram that depicts two graphs, one graph representing past interactions and another graph representing future interactions;

FIG. 2B is a block diagram that depicts the two interaction graphs, one of which is supplemented with artificial pairings, in an embodiment;

FIGS. 3A-3B are flow diagrams that depict an example process for generating training data for a machine-learned model, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for generating training data for a machine-learned model are provided. In one technique, interaction data is analyzed to generate (1) a first set of user-entity pairs that reflect interactions that occurred during a first time period and (2) a second set of user-entity pairs that reflect interactions that occurred during a second time period that is subsequent to the first time period. The interaction data includes information about past interactions between users and content associated with entities. The first set of user-entity pairs is supplemented by adding user-entity pairs based on a connection graph, even though the added user-entity pairs do not exist in the first set of user-entity pairs.

For each user-entity pair in the first set of user-entity pairs, if that user-entity pair also exists in the second set of user-entity pairs, then a training instance for the user-entity pair is generated with a positive label. However, if the user-entity pair does not exist in the second set of user-entity pairs, then a training instance is generated with a negative label. Either way, the training instance includes values of multiple features pertaining to the user, to the entity, and/or to both the user and the entity.

Embodiments improve computer-related technology, namely, machine learning technology. Example improvements include less training data (and, thus, less time and computer resources) to train an accurate machine-learned model due to how the training data is generated. Some embodiments involve generating training data based on data from different verticals in order to capture users' online behavior with respect to different entities, resulting in significant metric lifts.

### System Overview

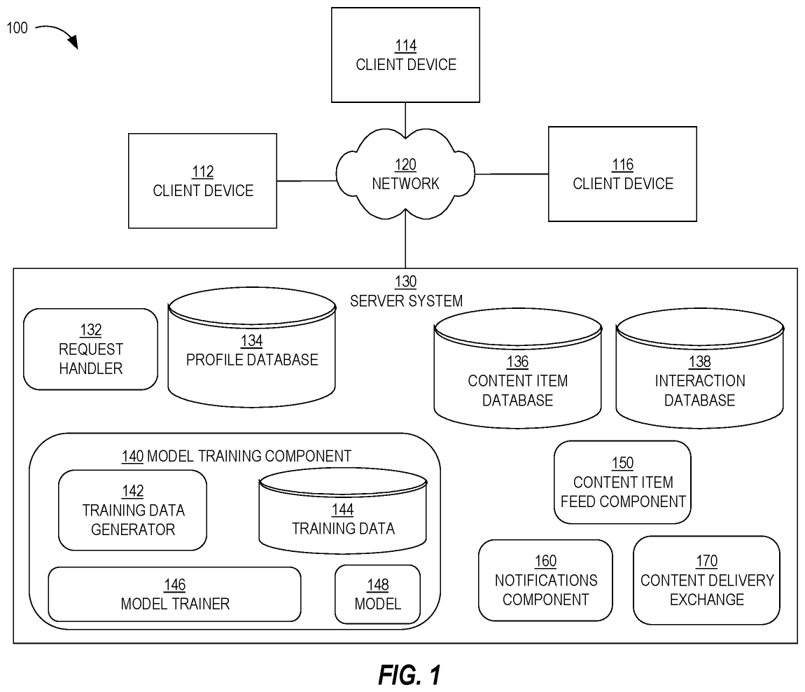

FIG. 1 is a block diagram that depicts an example system 100 for training a machine-learned model, in an embodiment. System 100 includes client devices 112-116, a network 120, and a server system 130. Although only three client devices are depicted, many client devices may be communicatively coupled to server system 130 through network 120 and/or other networks (not depicted). Server system 130 comprises one or more computing elements that perform the operations described herein as being performed by server system 130.

Network 120 is a computer network, examples of which include a local area network (LAN), a wide area network (WAN), and the Internet.

Examples of client devices 112-116 include a desktop computer, a laptop computer, a tablet computer, a wearable device, a video game console, and a smartphone.

A client device may receive content from server system 130 in response to transmitting a content request over network 120 to server system 130. Examples of a content request include a search request and a page request. A search request includes one or more query terms that are entered through the client device through one or more ways, such as through a physical keyboard of the client device or a graphical keyboard that is presented on a touchscreen display of client device 112. A page request includes a uniform resource locator (URL) that server system 130 hosts.

A client application executing on the client device transmits the content request to server system 130. Examples of such a client application include (1) a web application that executes within a web browser that executes on the client device and (2) a native application that is installed on the client device and is configured to communicate with server system 130.

A client device may receive content from server system 130 not in response to a content request from the client device. For example, server system 130 identifies content that server system 130 determines is relevant to a user of the client device and sends, to the client device or to an account of the user, a notification of the content in the form of an instant message, a text message, an email message, a push notification, or an in-app notification. Later, the user, operating the client device or another device, views the notification and determines whether to select any links to content found in the notification, the links referencing content hosted by server system 130 and/or another computer system.

### Server System

Server system 130 includes a request handler 132, a profile database 134, content item database 136, an interaction database 138, a model training component 140, a content item feed component 150, a notifications component 160, and a content delivery exchange 170. Model training component 140 includes a training data generator 142, training data 144, a model trainer 146, and a model 148. Each of request handler 132, content item feed component 150, notifications component 160, content delivery exchange 170, training data generator 142, and model trainer 146 is implemented in software, hardware, or any combination of software and hardware.

Request handler 132 processes content requests received from client devices 112-116. Profile database 134 is described in more detail herein. Content item database 136 stores multiple content items. Examples of content items include articles, posts that users create and that appear on their respective profiles or in content item feeds of other users, opportunity (e.g., job) listings, and advertisements. Profiles may be considered a type of content item.

Request handler 132 receives a content request and responds to the content request depending on the type of request. For example, if the content request is a search request, then request handler 132 causes a search to be performed by searching content item database 136, which may comprise multiple databases, each corresponding to a different content item type, or may comprise a single database that stores content items of multiple types.

As another example, if the content request is a page request, then request handler 132 causes a web content to be assembled from multiple data sources. For example, a content request may be a profile page request and request handler 132 causes a profile from profile database 134 to be retrieved and multiple content items from content item database 136 to be retrieved, and cause both to be included in an HTML document.

### Profile Database

Profile database 134 stores multiple entity profiles. Each entity profile in profile database 134 is provided by a different user. Example entities include users, groups of users, and organizations (e.g., companies, associations, government agencies, etc.). Each entity profile is provided by a different user or group/organization representative. An organization profile may include an organization name, a website, one or more phone numbers, one or more email addresses, one or more mailing addresses, a company size, a logo, one or more photos or images of the organization, an organization size, and a description of the history and/or mission of the organization.

A user profile may include a first name, last name, an email address, residence information, a mailing address, a phone number, one or more educational/academic institutions attended, one or more academic degrees earned, one or more current and/or previous employers, one or more current and/or previous job titles, a list of skills, a list of endorsements, and/or names or identities of friends, contacts, connections of the user, and derived data that is based on actions that the user has taken. Examples of such actions include opportunities (e.g., jobs) to which the user has applied, views of job postings, views of company pages, private messages between the user and other users in the user's connection network, and public messages that the user posted and that are visible to users outside of the user's connection network (but that are registered users/members of the connection network provider).

Some data within a user's profile (e.g., work history) may be provided by the user while other data within the user's profile (e.g., skills and endorsement) may be provided by a third party, such as a “friend,” connection, or colleague of the user.

Server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another automatic process). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

While many examples herein are in the context of online connection networks (e.g., social networks), embodiments are not so limited.

### Event Logging

Server system 130 may log one or more types of events, with respect to content items, across client devices 112-116 (and other client devices not depicted). The events are stored in interaction database 138. For example, server system 130 determines whether a content item that was delivered to a client device is presented at (e.g., displayed by or played back at) a client device. Such an “event” is referred to as an “impression.” As another example, server system 130 determines whether a user interacted with a content item that server system 130 delivered to a client device of the user. Examples of “user interaction” include a view or a selection, such as a “click.” Server system 130 stores such data as interaction data, such as an impression data set and/or an interaction data set. Thus, server system 130 include an interaction database 138. Logging such events allows server system 130 to track how well different content items perform.

For example, server system 130 receives impression data items, each of which is associated with a different instance of an impression and a particular content item. An impression data item may indicate a particular content item (e.g., through a content item identifier), a date of the impression, a time of the impression, a particular publisher or source (e.g., onsite v. offsite), a particular client device that displayed the specific content item (e.g., through a client device identifier), and/or a user identifier of a user that operated the particular client device. Thus, if server system 130 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. Thus, each interaction data item associates a user with a content item. An interaction data item may be supplemented with an entity identifier that identifies an entity that created or authored the content item and/or that is referenced in the content item. Such supplementation may be automatically performed at or near the time the interaction data item is created or may be automatically performed sometime later.

If impression data items are generated and processed properly, an interaction data item should be associated with an impression data item that corresponds to the interaction data item. From interaction data items and impression data items associated with a content item, server system 130 may calculate an observed (or actual) user interaction rate (e.g., CTR) for the content item. Also, from interaction data items and impression data items associated with a content delivery campaign (or multiple content items from the same content delivery campaign), server system 130 may calculate a user interaction rate for the content delivery campaign. Additionally, from interaction data items and impression data items associated with a content provider (or content items from different content delivery campaigns initiated by the content item), server system 130 may calculate a user interaction rate for the content provider. Similarly, from interaction data items and impression data items associated with a class or segment of users (or users that satisfy certain criteria, such as users that have a particular job title), server system 130 may calculate a user interaction rate for the class or segment. In fact, a user interaction rate may be calculated along a combination of one or more different user and/or content item attributes or dimensions, such as geography, job title, skills, content provider, certain keywords in content items, etc.

In an embodiment, interaction data items are generated from multiple data sources or verticals, examples of which include content item feed, notifications, news, follows, and search. Each of these verticals allows users to perform actions, such as selecting a content item in a feed, selecting a notification, subscribing to certain news articles, selecting a follow recommendation, selecting a search suggestion, and selecting a search result. Each of these actions may pertain to (or be associated with) an entity. For example, a content item that a user selects may have been created by a particular entity (e.g., a company), a follow recommendation may be to follow content produced by a university, and a subscription may be to news articles that reference a government agency.

### Connection Data

In an embodiment, server system 130 stores connection data that associates two nodes in a connection graph with each other. A node in the connection graph represents a user or an entity. The connection graph may or may not be embodied in actual nodes and edges that connect the nodes. Instead, the connection graph may be implicit in the connection data. The connection data may be part of profile database 134 or may be stored separately from profile database 134. For example, a user profile for user X includes connection data that identifies users Y and Z as connections of user X. Thus, each user profile in profile database 134 may include connection data of that user profile. Thus, the collective connection data may be viewed as the connection graph although actual nodes and edges might not exist in storage.

Two nodes are connected through an edge. Thus, an edge associates two users, two entities, or a user and an entity. An edge may have a type. Example types of edges include a connection, an interaction, and a similarity. For example, if two users provide, to server system 130, input that confirms that the two users know each other and are willing to share profile information with each other (including connection data), then the two users are considered connections or friends with each other. A user may have many such connections. The set of connections that a user has established through an online connection network system (e.g., LinkedIn) is referred to as a connection network (or a social network) of the user.

As another example, if a user follows or “likes” an entity by selecting a follow button or a like button on an entity profile page, then an edge connecting a node for the user to a node for the entity is an interaction type of edge. Or if a user clicks on a content item (that is associated with an entity) that appears in a content item feed presented (by server system 130) to the user, then an edge connecting a node for the user to a node for the entity is an interaction type of edge.

As another example, if two users are similar in many respects (e.g., a majority of their respective profile attribute values match), then the two users are connected with a similarity type of edge.

### Content Item Feed Component

Content item feed component 150 generates a content item feed for each client device that transmits a feed request to server system 130. A content item feed is a set of content items that is presented on a screen of a client device. A content item feed (or simply “feed”) includes user interface controls for scrolling through the feed. A user interface control for receiving user input to scroll through a feed is referred to as a scroll element or “thumb.” Content items within feed may be scrolled up and down or side to side. comprises. A feed may have a limited number of content items or may be an “infinite” feed where, as the feed is being scrolled through (whether automatically or in response to user input), additional content items (that have not yet been presented in the feed) are presented.

A content item feed contains multiple types of content items. One type of content item (referred to herein as the “first type”) is one that has been created by external content providers (not depicted) and that is associated with a content delivery campaign having targeting criteria that are used to identify the user or client device that is presenting the content item.

Another type of content item (referred to herein as the “second type”) is content that is generated based on activity of users in an online connection network of the user that is viewing the content item. Examples of such a content item include a content item identifying an article authored by a friend or connection of the user in the online connection network, a content item identifying an article interacted with (e.g., selected, viewed, commented, liked, shared) by such a friend or connection, a content item identifying a change in a status of such a friend, a content item identifying news pertaining to an entity (e.g., company, academic institution, community organization) with which the user is associated or affiliated, or of which the user a member (e.g., as specified in the user's online connection network).

Another type of content item (referred to herein as the “third type”) is a content item indicating a type of content in which server system 130 (or an affiliated system) predicts the user might be interested. Examples of types of recommended content include people (i.e., potential friends/connections), jobs, and video courses. Such content items do not originate from external content providers and are not part of a content delivery campaign. However, the source of the jobs and the authors/providers of the video courses may be third-party entities relative to server system 130.

In an embodiment, content item feed component 150 invokes a machine-learned model that takes, as input, a score produced by model 148. The score represents an affinity between a user and an entity. If a content item is a candidate for presenting, to the user, in a content item feed and the content item is associated with the entity, then output from model 148 (pertaining to the user and the entity) is used as input to another machine-learned model that is used to score candidate content items.

### Other Downstream Components

Content item feed component 150 is one example of a component that is downstream relative to model training component 140 and, thus, relies (directly or indirectly) on model 148 in making decisions. Notifications component 160, content delivery exchange 170, and follow component 180 are other examples of downstream components that may rely on model 148 in making decisions. For example, notifications component 160, after identifying a set of candidate content items, zero or more of which a notification may be generated, invokes model 148 by, for example, sending, to a scoring service that implements model 148, a user identifier of a user that may receive the yet-to-be-generated notification(s) and an entity identifier that identifies an entity that is associated with the candidate content item. The scoring service uses the respective identifiers to retrieve and generate feature values to input to model 148 and returns output of model 148 to notifications component 160, which may input that output into its own scoring model that is used to score (and, optionally, rank) the set of candidate content items.

As another example, content delivery exchange 170, after identifying a set of candidate content items, one or more of which may appear as content items in a profile page, a feed page, an opportunities page, or other type of page, invokes model 148 by, for example, sending, to a scoring service that implements model 148, a user identifier of a user that may receive the yet-to-be-generated notification(s) and an entity identifier that identifies an entity that provided (or is otherwise associated with) the candidate content item. The scoring service uses the respective identifiers to retrieve and generate feature values to input to model 148 and returns output of model 148 to content delivery exchange 170, which may input that output into its own scoring model that is used to score (and, optionally, rank) the set of candidate content items.

As another example, follow component 180, after identifying a set of candidate entities, zero or more of which a recommendation may be generated for a user to follow, invokes model 148 by, for example, sending, to a scoring service that implements model 148, a user identifier of a user that may receive the yet-to-be-generated recommendation(s) and an entity identifier that identifies an entity that is associated with the candidate entity. The scoring service uses the respective identifiers to retrieve and generate feature values to input to model 148 and returns output of model 148 to follow component 180, which may input that output into its own scoring model that is used to score (and, optionally, rank) the set of candidate entities.

A “follow recommendation” is a recommendation to a user regarding one or more entities to “follow.” A user “following” an entity means that the user will be notified of certain content associated with the entity. The notification may occur even though the user is offline or not interaction with server system 130, such as through an in-app notification or a push notification. Additionally or alternatively, the notification may occur when the user accesses a certain page or content hosted by server system 130. The content about which the user is notified may be content that the followed entity produces or content that mentions or refers to the followed entity, even though the content may be authored by an unrelated entity.

### Rule-Based Model

Scoring user-entity pairs based on feature data may be performed in a number of ways. For example, rules may be established that identify certain profile attributes of a user and of an entity and/or count certain activities of a user, each profile attribute and count corresponding to a different score and, based on a combination of all the scores, determine a score for the user-entity pair. For example, a user “following” an entity online may result in three points, the user establishing one or more connections with employees of the entity may be result in five points (bringing the total to eight points), and the user sending multiple messages to those employees may result in ten points (bringing the total to eighteen points). If a user reaches twenty points, then it is predicted that the user will select a content item that is associated with the company.

Rules may be determined manually by analyzing characteristics of entities and users who have selected content items associated with those entities in the past. For example, it may be determined that 56% of users who made a new connection to an employee of an entity, sent multiple messages to the new connection, and applied to multiple job positions associated with the entity ultimately selected a content item associated with the entity.

A rule-based model has numerous disadvantages. One disadvantage is that it fails to capture nonlinear correlations. For example, if a user clicks on (or otherwise selects) a significant number of content items associated with an entity, then the model may compute a high score for the user-entity pair, since the user accumulates, for example, five points for each click on a content item associated with the entity. However, there may be diminishing returns for each click after a certain number. Most users may request, for example, between five and eight clicks within a week period. Clicking on content items past this may not indicate a significant probability of other types of positive interaction with the entity. In fact, it may even be the case that clicking on many content items is a negative signal for such other types of positive interaction. For example, such behavior could indicate a fraudulent entity or application that clicks on many content items. In addition, complex interactions of features cannot be represented by such rule-based models.

Another issue with a rule-based prediction model is that the hand-selection of values (e.g., weights or coefficients) for each feature is error-prone, time consuming, and non-probabilistic. Hand-selection also allows for bias from potentially mistaken business logic.

A third disadvantage is that output of a rule-based model is an unbounded positive or negative value. The output of a rule-based model does not intuitively map to the probability of a click, conversion, or other type of action for which the model is optimizing (e.g., predicting). In contrast, machine learning methods are probabilistic and therefore can give intuitive probability scores.

### Machine Learning

In an embodiment, one or more models are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users. The statistical model is trained based on multiple attributes (or factors) described herein. In machine learning parlance, such attributes are referred to as “features.” To generate and train a statistical model, a set of features is specified and a set of training data is identified.

Training data generator 142 generates training data 144 based on data stored in profile database 134, content item database 136, and/or interaction database 138. Model trainer 146 trains model 148 based on training data 144 using one or more machine learning techniques. Embodiments are not limited to any particular machine learning technique for generating or training model 148. Example machine learning techniques include linear regression, logistic regression, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

Model 148 may output different types of data or values, depending on the input features and the training data. For example, each training instance in training data 144 comprises a label and multiple feature values, each corresponding to a different feature. Example features are described in more detail herein. In order to generate training data 144, information about each user-entity pair is retrieved and zero or more operations are applied thereto to compute the different feature values.

The label of each training instance may be whether the corresponding user interacted with a content item associated with the corresponding entity in a certain period of time. For example, a label value of ‘1’ indicates that the user interacted with the content item while a label value of ‘0’ indicates that the user did not interact with the content item.

Initially, the number of features that are considered for training may be significant, such as in the hundreds. After training a machine-learned model and validating the model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Model trainer 146 (or an administrator) identifies and removes, from the training data 144, features will little predictive power. Removing such features can speed up the process of training future versions of model 148 and computing output scores.

### Model Features

In an embodiment, training data generator 142 uses an interaction data item (from interaction database 138) to generate a training instance. Depending on the features of model 148 to be trained, the number and type of features may vary greatly. Examples of types of features include user features, entity features, user-entity interaction features, and user-entity network features. Model 148 may include one or more of these types of features.

Examples of user features of a user include a number entities that the user follows in an online connection network, an industry of the user, a job function of the user, a job title of the user, an employment status of the user, a technical degree earned by the user, and an academic institution attended by the user. Such features may be retrieved from a profile (of the user) stored in profile database 134.

Examples of entity features include an industry of the entity, a number of employees and/or contractors that that entity employs, a number of opportunity postings that the entity has listed on one or more opportunity posting platforms, a number of users that follow the entity in the online connection network (or “followers of the entity”), a number of followers of the entity who are not employed by the entity, and a ratio of (a) the number followers of the entity who are also employed by the entity to (b) a total number of followers of the entity.

Examples of user-entity interaction features include whether the user and the entity are associated with the same industry, whether the user is currently following the entity, whether the user was ever (or currently) employed by the entity, a number of job-related interactions that the user has had with the entity (e.g., in the last 28 days), a number of views by the user of a profile page of the entity (or of pages/articles that mention or are about the entity), a number of viral actions by the user with respect to content items associated with the entity, and a cosine similarity between an embedding that has been machine-learned for the user (user embedding) and an embedding that has been machine-learned for the entity (entity embedding).

Examples of user-entity network features include whether a user and an entity are directly connected in an online connection network and, if the user and entity are not directly connected, a number of shared user nodes between the user and the entity in the online connection network. The user and entity are directly connected in the online connection network if one or more criteria are satisfied. Example criteria include whether the user performed a viral action with respect to the entity (e.g., follows the entity, liked a profile page of the entity) or whether the user performed a private action with respect to the entity (e.g., clicked on a certain number of content items associated with the entity, viewed a certain number of pages associated with the entity, performed a job-related action with respect to the entity).

Some of these features are considered “raw” features. A raw feature is one whose values already exist in storage without having to perform any transformation or aggregation operations. For example, a profile attribute (e.g., industry of a user or of an entity) in profile database 134 in an example of a raw feature. Some features of model 148 may come directly from raw features while other features of model 148 may be generated based on raw features. Such generated features are referred to as “derived features.” Values of derived features are generated using one or more transformations of the values of raw features. For example, a raw feature may be a single interaction data item that indicates that a user performed a viral action (e.g., share, comment, like) with respect to a content item associated with an entity. A derived feature may be a number of viral actions that the user performed with respect to content items associated with the entity for the last 28 days. In order to generate a value for this derived feature, interaction database 138 is searched to identify each interaction data item that includes a user identifier for the user, an entity identifier for the entity (or a content item identifier that maps to the entity identifier), and a timestamp whose date is within the last 28 days of the current date.

### Generating Training Data

As noted herein, training data generator 142 uses interaction data items to generate multiple training instances, one for each interaction data item. By limiting the training instances to interaction data items, the size of training data 144 is kept from being too large. Instead, if all edges in a connection graph were taken into account (the connection graph comprising all users in an online connection network and all possible entities that are identified in the online connection network and/or other data sources), then the training data would be too large, since the training data would include negative training instances for user-entity pairs that had no interactions. The number of users in an online connection network may be millions or hundreds of millions, while the number of content items that may be presented to users in the online connection network may similarly be millions or hundreds of millions. Therefore, the processing time and computing resources necessary to generate billions or trillions of training instances alone would be substantial.

In an embodiment, two different sets of interaction data items are used to generate training data 144. One of the two sets corresponds to interactions that occurred during a first time period and the other of the two sets corresponds to interactions that occurred during a second time period. The set of interaction data items that corresponds to the earlier time period is referred to as the “past interaction data items” while the set of interaction data items that corresponds to the later time period is referred to as the “future interaction data items.” For example, interactions that occurred in the month of May of a particular year are identified as well as interactions that occurred in the month of June of the particular year. The interaction data items that were generated in May become the past interaction data items, while the interaction data items that were generated in June become the future interaction data items. The future interaction data items are “future” with respect to the past interaction data items. In an embodiment, the two time periods do not overlap.

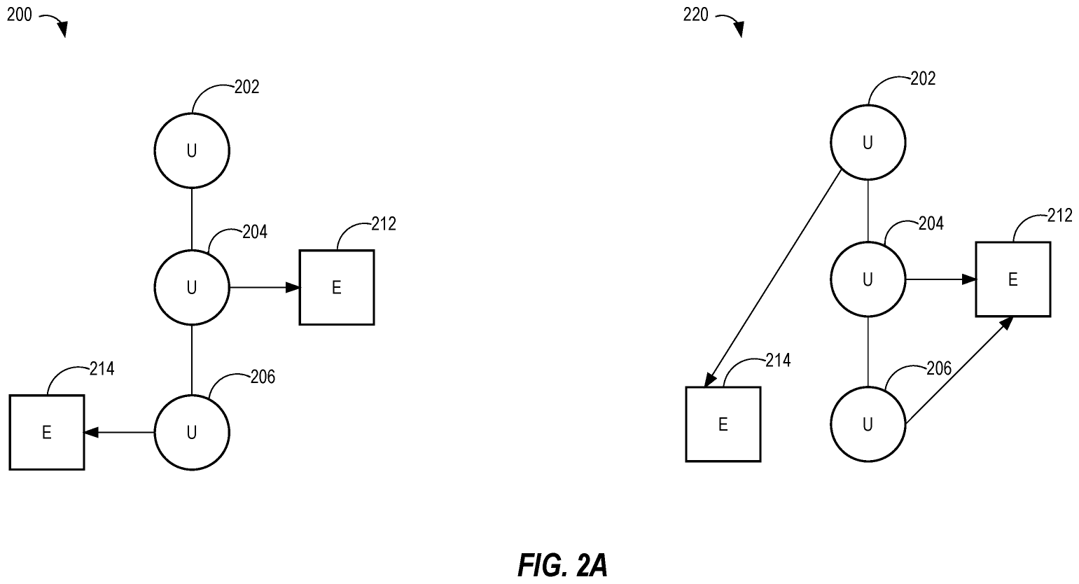

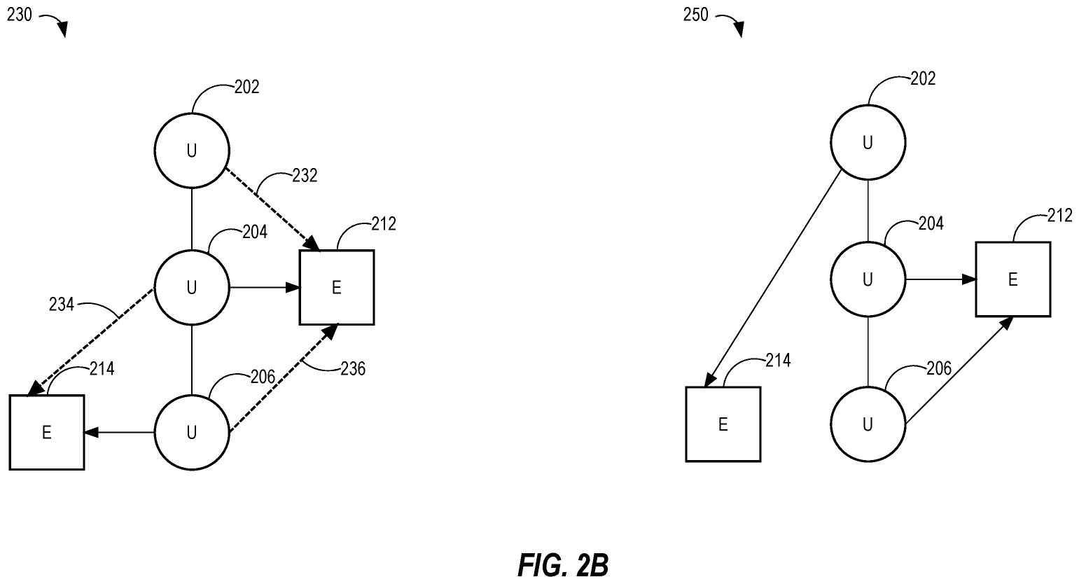

FIG. 2A is a block diagram that depicts two graphs, graph 200 representing past interactions and graph 220 representing future interactions. Each graph includes nodes, each representing either a user or an entity. Each graph includes edges, each representing either a connection between two users or an interaction (i) by a user (ii) of a content item associated with an entity. Thus, graph 200 indicates that (1) users 202 and 204 are connections in an online connection network, (2) users 204 and 206 are connections in the online connection network, (3) user 204 interacted with a content item associated with entity 212, and (4) user 206 interacted with a content item associated with entity 214. Thus, the past interaction data items would reflect (3) and (4).

Graph 220 indicates that (1) users 202 and 204 are still connections in the online connection network, (2) users 204 and 206 are still connections in the online connection network, (3) user 202 interacted with the content item associated with entity 214, (4) user 204 interacted with the content item associated with entity 212, and (5) user 206 interacted with the content item associated with entity 212. Thus, the future data items would reflect (3) and (4).

As described herein, each interaction data item identifies a user and an entity, either directly or indirectly. For example, an interaction data item includes (1) a user identifier that uniquely identifies a user that is the subject of the interaction (or that performed the interaction, such as a viral action, a click, or a save) and (2) a content item identifier that uniquely identifies a content item that is the object of the interaction (e.g., the content item that the user clicked, played, etc.). The content item identifier may be mapped to an entity identifier in a mapping that maps content items to entities that are associated with (e.g., created, produced, identified in) the content items. Alternatively, an interaction data item includes an entity identifier of the corresponding entity.

Some interaction data items may include entity identifiers while others do not, in which case one or more mappings are retrieved and used to map a content item identifier to an entity identifier.

In an embodiment, training data generator 142 only considers interaction data items in the past interaction data items when generating training instances. Thus, if an interaction data item only exists in the future interaction data items, then the interaction data item is not used to generate a training instance. Instead, the future interaction data items are used to determine what label value to set for training instances that are generated. Two instances of the same interaction data item exist in both sets of interaction data items if the two instances identify the same user and are associated with the same entity. If an interaction data item in the past set also exists in the future set, then training data generator 142 generates a training instance with a positive label (or a “positive training instance”). If an interaction data item in the past set does not exist in the future set, then training data generator 142 generates a training instance with a negative label (or a “negative training instance”).

### Artificial Pairings

In an embodiment, model training component 140 supplements the past interaction data items with “artificial” pairings. An artificial pairing is similar to a past interaction data item except that an artificial pairing identifies a user and an entity where there was no interaction between the user and a content item of the entity, at least in the time period defined by the past interaction data items. Nevertheless, model training component 140 generates artificial pairings using second degree connections in a connection graph, or connection data associated with users that are identified in the past interaction data items.

For example, model training component 140 generates an artificial pairing that identifies a first user and a first entity if an interaction data item (that exists in the past interaction data items) identifies a connection of the first entity and a content item that is associated with the first entity. Thus, if the connection has twenty connections, then model training component 140 generates twenty artificial pairings, from which training data generator 142 may generate twenty training instances, if such pairings do not already exist in the past interaction data items. In this way, the number of artificial pairings may be significantly larger than the number of interaction data items in the past non-artificial interaction data items and in the future interaction data items.

In an embodiment, the number of artificial pairings is limited so that too many artificial pairings are not automatically generated. For example, a maximum of ten artificial pairings are generated per user that is identified in the past interaction data items. The top ten connections of such a user may be the connections that are most similar to the user along one or more attributes, such as job title, industry, employer name, geography, language, and certain online behavior, such as selections of content items associated with the same topic or entity and applications to the same type of jobs.

As another example, artificial pairings are only generated where the users identified in the artificial pairings are also found in the past interaction data items.

As another example, artificial pairings are only generated where the entities identified in the artificial pairings are also found in the past interaction data items.

As another example, artificial pairings are only generated where each entity identified in an artificial pairing is an entity that is considered trending in a geographical area of the corresponding user.

As another example, a combination of one or more of the above artificial pairings are generated.

FIG. 2B is a block diagram that depicts the two interaction graphs, one of which is supplemented with artificial pairings, in an embodiment. Graph 250 is identical to graph 220. Graph 230 is similar to graph 200 except that graph 230 is supplemented with artificial pairings, each based on connections between users 202, 204, and 206. Thus, pairing 232 is based on (1) the connection between users 202 and 204 and (2) the interaction between user 204 and the content item associated with entity 212; pairing 234 is based on (3) the connection between users 204 and 206 and (4) the interaction between user 206 and the content item associated with entity 214; and pairing 236 is based on (5) the connection between users 204 and 206 and (6) the interaction between user 204 and the content item associated with entity 212.

### Contextualization

In an embodiment, model trainer 146 trains two versions of model: one based on “private” interactions and one based on “public” interactions. Examples of private interactions include user selections (e.g., clicks) of a content item, saves (e.g., of an opportunity listing), extended views of a content item (e.g., of a video item), applications to an opportunity listing, filling out a form, and registering for an event or a service.

Examples of public interactions include online activities relative (or with respect) to content items, which activities are visible to other users, such as other users in the acting user's connection network. Examples of such online activities include likes, postings, comments, and shares.

A version of model 148 that is trained solely based on private interactions is referred to as a “private contextual model” and a version of model 148 that is trained solely based on public interactions is referred to as a “public contextual model.” The features of both versions of the model may be exactly the same or may be different. For example, one or more features related to private actions may appear in the private contextual model but not in the public contextual model. However, one or more features related to public actions may appear in both the private contextual model and the public contextual model.

Thereafter, either or both the private contextual model and the public contextual model may be invoked. For example, because notifications component 160 generates scores that are used to predict whether a user is going to perform a private action relative to a notification, then notifications component 160 may rely on the private contextual model to produce output that is used as input to one or more models relied upon by notifications component 160. On the other hand, because content item feed component 150 generates scores that are used to predict whether a user is going to perform a public action relative to a content item, then content item feed component 150 may rely on the public contextual model to produce output that is used as input to one or more models relied upon by content item feed component 150.

Experiments have shown that “contextualization,” or using private and public contextual models depending on the context, has yielded positive results (relative to a non-contextual model) in predicting online user behavior, such as clicks, saves, pages views, opportunity listing views, and opportunity applications.

### Model Scoring

In an embodiment, model 148 (or a version thereof) is invoked at runtime to generate a score for a user-entity pair. For example, in response to a feed request from client device 112, both content item feed component 150 and content delivery exchange 170 are invoked to identify content items for presentation on a screen of client device 112. Content item feed component 150 identifies content items of a first type and calls content delivery exchange 170 to identify content items of a second type that is different than the first type. In identifying content items of the first type, content item feed component 150 identifies a first set of candidate content items and uses a user identifier of the user and entity identifiers of entities associated with the first set of candidate content items to obtain a score from model 148 for each user-entity pair. Content item feed component 150 uses the scores to select a final set of content items from the first set of candidate content items. Similarly, in identifying content items of the second type, content delivery exchange 170 identifies a second set of candidate content items and uses a user identifier of the user and entity identifiers of entities associated with its set of candidate content items to obtain a score from model 148 for each user-entity pair. Content delivery exchange 170 uses the scores to select a final set of content items from the second set of candidate content items. Content item feed component 150 then assembles a content item feed that includes both final sets of content items and causes that content item feed to be presented to the user of client device 112.

However, run-time scoring (i.e., scoring multiple user-entity pairs in response to a content request from a client device) may take a significant amount of time resulting in poor user experience. Therefore, if possible, offline scoring of user-entity pairs is preferable. However, because there may be millions (e.g., hundreds of millions) of users and millions (e.g., tens of millions) of entities, it is not practical to compute a score using model 148 (or version thereof) for every possible user-entity pair.

In an embodiment, the training data generation process is used to identify the most relevant user-entity pairs for offline scoring. For example, only user-entity pairs involving (1) users that are referenced in a set (e.g., a past set) of interaction data items and (2) entities that are referenced in the set of interaction data items are scored. As another example, a score for a user-entity pair is only generated if one or more attributes (e.g., geographic region and/or industry) of the user and the entity match.

### Example Process

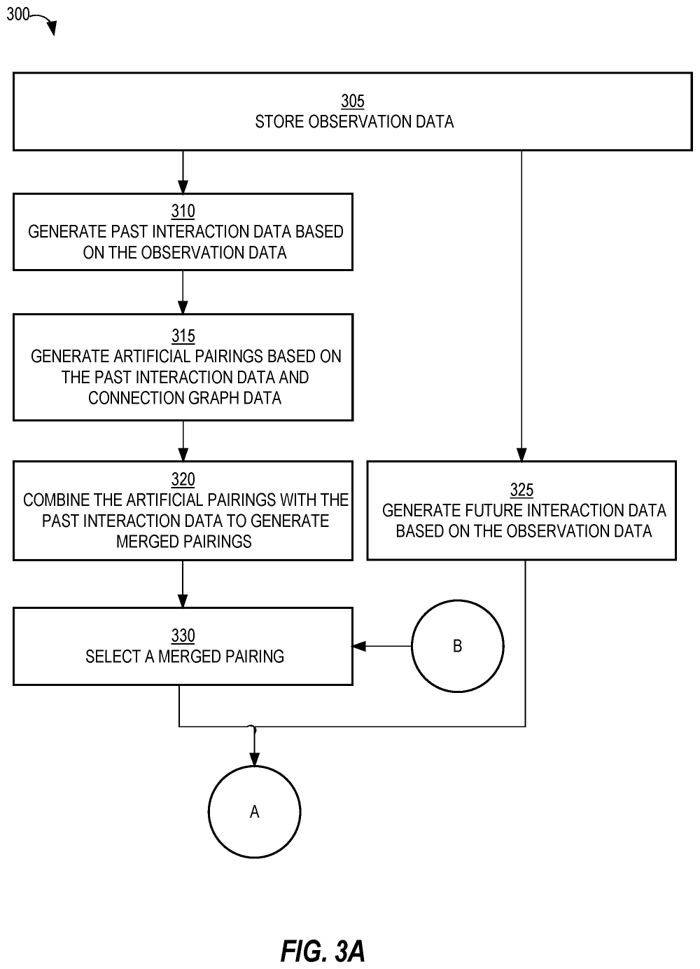

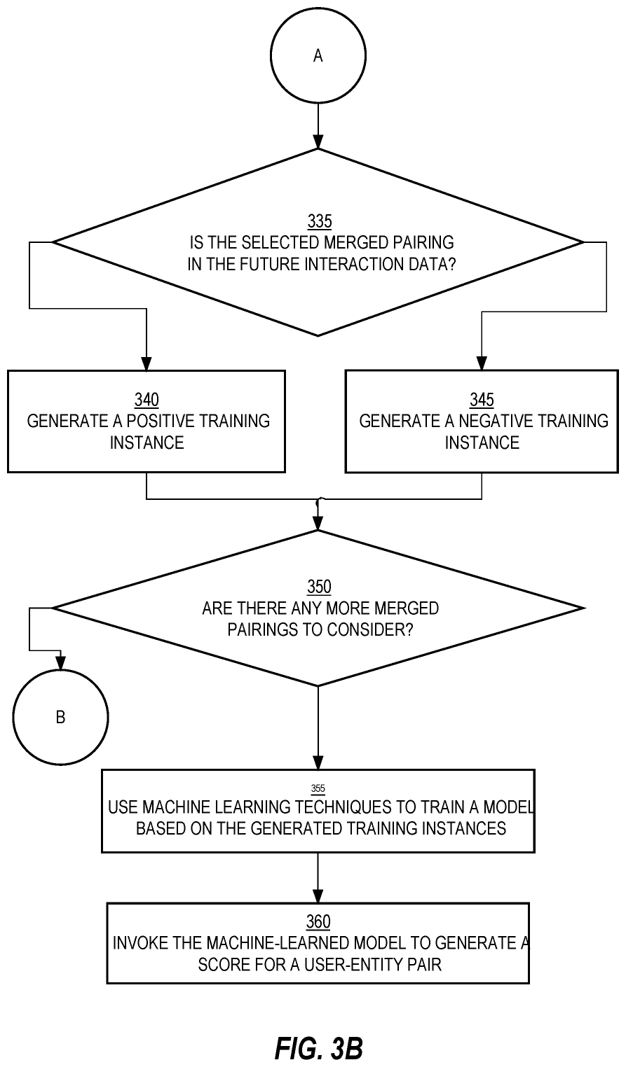

FIGS. 3A-3B are flow diagrams that depict an example process 300 for generating training data for a machine-learned model, in an embodiment. Process 300 is performed by one or more elements of server system 130. Different portions of process 300 may be performed at the same time, such as generating the respective past and future interaction data items.

At block 305, observation data is stored. The observation data may be stored in interaction database 138. The observation data indicates user interactions with content items. The observation data may include records for only interactions and, optionally, non-interactions, such as impression data items. Server system 130 records the past observation data based on information received from client devices 112-116 (e.g., impression data items) and, optionally, based on information that is not received from client devices 112-116 (e.g., the lack of click data items that correspond to the impression data items). For example, a click data item is matched to a corresponding impression data item in the observation data if the user identifier and content item identifier match and the respective timestamps are relatively close in time (e.g., three minutes).

At block 310, past interaction data items are generated based on the observation data. The past interaction data items are based on a subset of the observation data since the past interaction data items correspond to online activity that occurred in a specific time period in the past. Each past interaction data item associates a user with an entity, such as including a user identifier and an entity identifier. Block 310 may involve mapping a content item identifier in the observation data to an entity identifier. For example, server system 130 stores a mapping between (1) a content item identifier of each content item and (2) an entity identifier of (i) an entity that created or authored the content item or (ii) an entity that is mentioned or referenced in the content item.

At block 315, artificial pairings are generated based on the past observation data and connection graph data. An artificial pairing represents a second degree association between a user and an entity. Although a user indicated in an artificial pairing did not interact (at least during a time period corresponding to the past observation data) with a content item associated with the entity indicated in the artificial pairing, because the user is connected (in an online connection network) to someone who did interact with that content item, then the artificial pairing is generating. In an embodiment, not all connections of a user indicated in a past interaction data item are used to generated artificial pairings. For example, only the top N most similar connections to the user are selected and N artificial pairings are generated therefor. “Similar” connections may be ones that share certain attributes in common, such as having some of the same profile attributes in common (e.g., same job title, same industry, same geographic region) and/or having interacted with (e.g., liked, clicked, shared, commented on) the same content items in the past.

At block 320, the past interaction data items are combined or merged with the artificial pairings to generate “merged pairings.” The past interaction data items and the artificial pairings may be formatted identically. For example, each past interaction data item and each artificial pairing may consist of a user identifier and an entity identifier. The merged pairings may be ordered based on one or more ordering criteria, such as based on user identifier (e.g., in ascending order) and/or content item identifier. Such ordering may allow for faster comparisons in block 335.

At block 325, “future interaction data items” are generated based on the observation data. Again, the future interaction data items are only future with respect to the past interaction data items. Like the past interaction data items, the future interaction data items are based on a subset of the observation data since the future interaction data items correspond to online activity that occurred in a specific time period, which is after the time period corresponding to the past interaction data items. Thus, the future interaction data items may also be retrieved from interaction database 138 or from another database that corresponds to the time period of the future interaction data items.

Each future interaction data item associates a user with an entity, such as by including a user identifier and an entity identifier. Block 325 may involve mapping a content item identifier in the observation data to an entity identifier. Block 325 may also involve ordering the future interaction data items based on the same ordering criteria used to order the merged pairings.

At block 330, a merged pairing is selected. The first iteration of block 330 may involve selecting the first merged pairing in an ordered set of merged pairings. Then, subsequent iterations of block 330 pertaining to the same set of training data involve selecting the next merged pairing in the ordered set that has not yet been selected.

At block 335, it is determined whether the selected merged pairing exists in the future interaction data items. If the respective data sets are ordered, then this matching process may be performed efficiently, such that only a single pass through each data set may need to be performed in order to complete block 330. If the determination of block 335 is in the affirmative, then process 300 proceeds to block 340; otherwise, process 300 proceeds to block 345.

At block 340, a positive training instance or sample is generated. The positive training instance includes a label that indicates that the selected merged pairing is found in the future interaction data items. An example of a positive label is ‘1’. The training instance also include a set of feature values, each feature value corresponding to a feature of model 148. Examples of features of model 148 are those already described herein. Thus, block 340 involves computing feature values based on the user identifier and/or the entity identifier in the selected merged pairing. For example, the user identifier is used to retrieve values of attributes from a profile of the user and the entity identifier is used to retrieve values of attributes from a profile of the entity. The retrieved values are then analyzed to compute feature values for the training instance.

At block 345, a negative training instance or sample is generated. The negative training instance includes a label that indicates that the selected merged pairing is not found in the future interaction data items. An example of a negative label is ‘0’. Other than the specific label, block 345 is similar to block 340 as far as it pertains to feature value generation for the training instance.

At block 350, it is determined whether there are any more merged pairings to consider. If so, then process 300 returns to block 330, where another merged pairing is selected. Otherwise, once all the merged pairings from block 320 are considered, process 300 proceeds to block 355.

At block 355, one or more machine learning techniques are used to train model 148 based on the positive and negative training instances. Block 355 may be performed by model training component 140.

At block 360, model 148 is invoked by inputting, into model 148, feature values pertaining to a user-entity pair. Model 148 outputs a score that represents an affinity between the user and the entity of the user-entity pair, even though the user might not have interacted with any content item associated with the entity. Model 148 (or a copy thereof) may be invoked by different components, such as content item feed component 150, notifications component 160, and content delivery exchange 170, each providing feature values corresponding to different user-entity pairs. Alternatively each component provides a user identifier and an entity identifier and an invocation component that implements model 148 is responsible for (1) retrieving the raw data pertaining to the user and entity identifiers and (2) generating the feature values based on the raw data.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

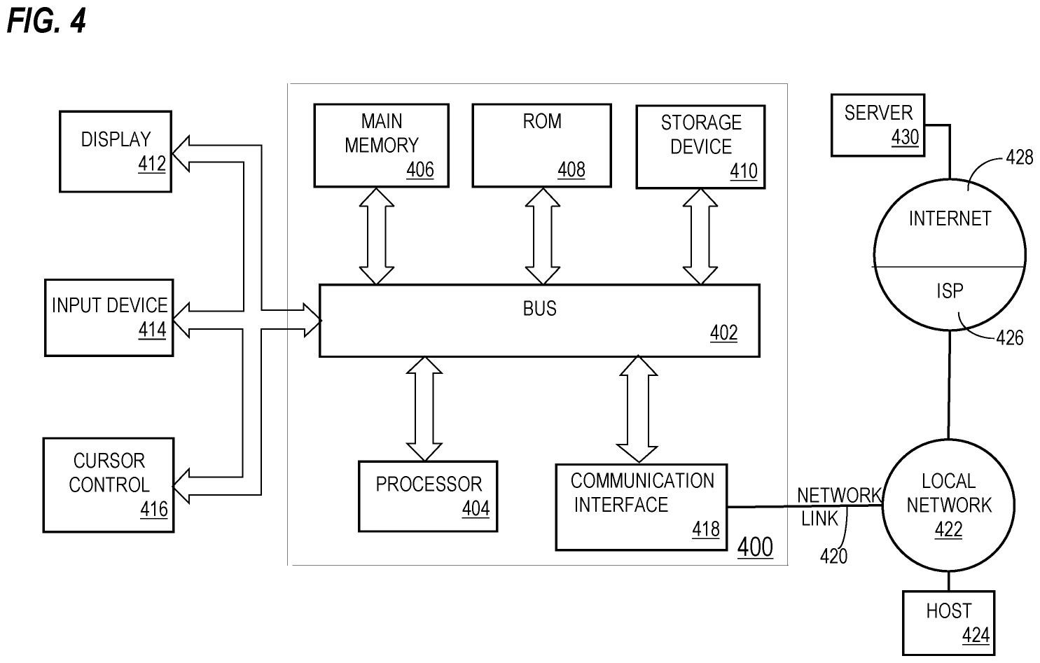

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing first interaction data that indicates a first plurality of interactions, that occurred during a first time period, between a first set of users and content items associated with a first set of entities;
wherein each interaction in the first plurality of interactions corresponds to a user-entity pair;
storing second interaction data that indicates a second plurality of interactions, that occurred during a second time period that is after the first time period, between a second set of users and content items associated with a second set of entities;
for each interaction in the first plurality of interactions:
generating a training instance based on a plurality of features of the user and the entity in the user-entity pair that corresponds to said each interaction;
determining whether said each interaction matches an interaction in the second interaction data;
if said each interaction does not match an interaction in the second interaction data, then generating a negative label for the training instance;
if said each interaction matches an interaction in the second interaction data, then generating a positive label for the training instance;
adding the training instance to training data;
using one or more machine learning techniques to train a machine-learned model based on the training data;
wherein the method is performed by one or more computing devices.

2. The method of claim 1, further comprising:
storing connection data that indicates, for each user in a subset of the first set of users, one or more other users to which said each user is connected in an online connection network;
prior to determining whether each interaction in the first plurality of interactions matches an interaction in the second interaction data, based on the connection data, adding a plurality of secondary interactions to the first plurality of interactions;
wherein, for each user-entity pair in the plurality of secondary interactions, the user in said each user-entity pair did not interact with a content item associated with the entity in said each user-entity pair during the first time period.

3. The method of claim 2, wherein adding the plurality of secondary interactions comprises:
for each user in the first set of users:
identifying a set of interactions, in the first plurality of interactions, that identify said each user;
identifying a subset, of the first set of entities, that correspond to the set of interactions;
identifying, from the connection data, a set of other users to which said each user is connected in the connection network;
for each other user in the set of other users, updating the first interaction data to include an interaction between said each other user and each entity in the subset of the first set of entities.

4. The method of claim 1, wherein the first plurality of interactions includes a first interaction of a first type and a second interaction of a second type that is different than the first type.

5. The method of claim 4, wherein:
the first type is one of a like, a share, or a comment of a first content item; and
the second type is one of a user selection of a second content item, watching video of a third content item, or applying to a job position.

6. The method of claim 4, wherein:
the first interaction is generated based on first data that is from a first data source and that is generated based on a first application;
the second interaction is generated based on second data that is (1) from a second data source that is different than the first data source and (2) generated based on a second application that is different than the first application.

7. The method of claim 1, wherein the machine-learned model is a first machine-learned model and the first plurality of interactions are limited to public interactions, the method further comprising:
storing third interaction data that indicates a third plurality of interactions, that occurred during a third time period, between a third set of users and content items associated with a third set of entities;
wherein the third plurality of interactions are limited to private interactions;
storing fourth interaction data that indicates a fourth plurality of interactions, that occurred during a fourth time period that is after the third time period, between a fourth set of users and content items associated with a fourth set of entities;
for each interaction in the third plurality of interactions:
generating a second training instance based on a second plurality of features of the user and the entity in the user-entity pair that corresponds to said each interaction;
determining whether said each interaction matches an interaction in the fourth interaction data;
if said each interaction does not match an interaction in the fourth interaction data, then generating a negative label for the second training instance;
if said each interaction matches an interaction in the fourth interaction data, then generating a positive label for the second training instance;
adding the second training instance to second training data;
using the one or more machine learning techniques to train a second machine-learned model based on the second training data.

8. The method of claim 1, wherein the plurality of features includes (1) a first set of features pertaining to a user and a second set of features pertaining to an entity and (2)(a) a third set of features pertaining to interactions between the user and the entity or (b) a fourth set of features pertaining to network features of the user and the entity.

9. The method of claim 8, wherein:
the first set of features includes a feature that is based on (i) an industry of the user or (ii) a number of entities that the user follows;
the second set of features includes a feature that is based on an industry of the entity, a number of employees of the entity, a number of job postings by the entity, a first number of followers of the entity, a second number of followers of the entity who are not employed by the entity, or a ratio of the second number of followers of the entity who are employed by the entity to the first number of followers of the entity;
the third set of features includes a feature that indicates whether the industry of the user is the same as the industry of the entity, whether the user is currently following the entity, or whether the user is employed by the entity, and a feature that is based on one or more of a number of job-related interactions by the user with respect to the entity, a number of views of a profile page of the entity by the user, a number of viral actions by the user with respect to content from the entity, a cosine similarity between an embedding of the user and an embedding of the entity;
the fourth set of features includes a feature that (c) indicates whether the user and the entity are directly connected in a node-edge graph or (b) is based on a number of shared common nodes between the user and the entity in the node-edge graph.

10. The method of claim 1, wherein the plurality of features includes:
a first feature that indicates whether a user provided first input to follow an entity,
a second feature that indicates whether the user was ever employed by the entity, and
a third feature that indicates whether the user provided second input that comprises a viral action with respect to content associated with the entity.

11. One or more storage media storing instructions which, when executed by one or more processors, cause:
storing first interaction data that indicates a first plurality of interactions, that occurred during a first time period, between a first set of users and content items associated with a first set of entities;
wherein each interaction in the first plurality of interactions corresponds to a user-entity pair;
storing second interaction data that indicates a second plurality of interactions, that occurred during a second time period that is after the first time period, between a second set of users and content items associated with a second set of entities;
for each interaction in the first plurality of interactions:
generating a training instance based on a plurality of features of the user and the entity in the user-entity pair that corresponds to said each interaction;
determining whether said each interaction matches an interaction in the second interaction data;
if said each interaction does not match an interaction in the second interaction data, then generating a negative label for the training instance;
if said each interaction matches an interaction in the second interaction data, then generating a positive label for the training instance;
adding the training instance to training data;
using one or more machine learning techniques to train a machine-learned model based on the training data.

12. The one or more storage media of claim 11, wherein the instructions, when executed by the one or more processors, further cause:
storing connection data that indicates, for each user in a subset of the first set of users, one or more other users to which said each user is connected in an online connection network;
prior to determining whether each interaction in the first plurality of interactions matches an interaction in the second interaction data, based on the connection data, adding a plurality of secondary interactions to the first plurality of interactions;
wherein, for each user-entity pair in the plurality of secondary interactions, the user in said each user-entity pair did not interact with a content item associated with the entity in said each user-entity pair during the first time period.

13. The one or more storage media of claim 12, wherein adding the plurality of secondary interactions comprises:
for each user in the first set of users:
identifying a set of interactions, in the first plurality of interactions, that identify said each user;
identifying a subset, of the first set of entities, that correspond to the set of interactions;
identifying, from the connection data, a set of other users to which said each user is connected in the connection network;
for each other user in the set of other users, updating the first interaction data to include an interaction between said each other user and each entity in the subset of the first set of entities.

14. The one or more storage media of claim 11, wherein the first plurality of interactions includes a first interaction of a first type and a second interaction of a second type that is different than the first type.

15. The one or more storage media of claim 14, wherein:
the first type is one of a like, a share, or a comment of a first content item; and
the second type is one of a user selection of a second content item, watching video of a third content item, or applying to a job position.

16. The one or more storage media of claim 14, wherein:
the first interaction is generated based on first data that is from a first data source and that is generated based on a first application;
the second interaction is generated based on second data that is (1) from a second data source that is different than the first data source and (2) generated based on a second application that is different than the first application.

17. The one or more storage media of claim 11, wherein the machine-learned model is a first machine-learned model and the first plurality of interactions are limited to public interactions, wherein the instructions, when executed by the one or more processors, further cause:
storing third interaction data that indicates a third plurality of interactions, that occurred during a third time period, between a third set of users and content items associated with a third set of entities;
wherein the third plurality of interactions are limited to private interactions;
storing fourth interaction data that indicates a fourth plurality of interactions, that occurred during a fourth time period that is after the third time period, between a fourth set of users and content items associated with a fourth set of entities;
for each interaction in the third plurality of interactions:
generating a second training instance based on a second plurality of features of the user and the entity in the user-entity pair that corresponds to said each interaction;
determining whether said each interaction matches an interaction in the fourth interaction data;
if said each interaction does not match an interaction in the fourth interaction data, then generating a negative label for the second training instance;
if said each interaction matches an interaction in the fourth interaction data, then generating a positive label for the second training instance;
adding the second training instance to second training data;
using the one or more machine learning techniques to train a second machine-learned model based on the second training data.

18. The one or more storage media of claim 11, wherein the plurality of features includes (1) a first set of features pertaining to a user and a second set of features pertaining to an entity and (2)(a) a third set of features pertaining to interactions between the user and the entity or (b) a fourth set of features pertaining to network features of the user and the entity.

19. The one or more storage media of claim 18, wherein:
the first set of features includes a feature that is based on (i) an industry of the user or (ii) a number of entities that the user follows;
the second set of features includes a feature that is based on an industry of the entity, a number of employees of the entity, a number of job postings by the entity, a first number of followers of the entity, a second number of followers of the entity who are not employed by the entity, or a ratio of the second number of followers of the entity who are employed by the entity to the first number of followers of the entity;
the third set of features includes a feature that indicates whether the industry of the user is the same as the industry of the entity, whether the user is currently following the entity, or whether the user is employed by the entity, and a feature that is based on one or more of a number of job-related interactions by the user with respect to the entity, a number of views of a profile page of the entity by the user, a number of viral actions by the user with respect to content from the entity, a cosine similarity between an embedding of the user and an embedding of the entity;
the fourth set of features includes a feature that (c) indicates whether the user and the entity are directly connected in a node-edge graph or (b) is based on a number of shared common nodes between the user and the entity in the node-edge graph.

20. The one or more storage media of claim 11, wherein the plurality of features includes:
a first feature that indicates whether a user provided first input to follow an entity,
a second feature that indicates whether the user was ever employed by the entity, and
a third feature that indicates whether the user provided second input that comprises a viral action with respect to content associated with the entity.
